(19) United States
(12) Patent Application Publication
(10) Pub. No.: US 2009/0134306 A1
(43) Pub. Date: May 28, 2009

(54) HEARING AID AND SUPPORTING HOOK TO BE ATTACHED TO A HEARING AID

(75) Inventor: Wee Haw Koo, Singapore (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/275,522

(22) Filed: Nov. 21, 2008

(30) Foreign Application Priority Data
Nov. 21, 2007 (DE) 10 2007 055 550.6

(51) Int. Cl. A47G 29/00; H04R 25/00

(52) U.S. Cl. 248/692; 381/330

(57) ABSTRACT

A supporting hook to be attached to a hearing aid, includes a connection end, an output end and an attachment ring. The connection end has a guide, around which the attachment ring is rotatably mounted. The attachment ring has a protrusion which engages with part of the hearing aid in order to attach the connection end to the hearing aid. A hearing aid is also provided.

### CROSS-REFERENCE TO RELATED APPLICATION

This application claims the priority, under 35 U.S.C. § 119, of German Patent Application DE 10 2007 055 550.6, filed Nov. 21, 2007; the prior application is herewith incorporated by reference in its entirety.

### BACKGROUND OF THE INVENTION

1. Field of the Invention

The invention relates to a supporting hook to be attached to a hearing aid. The invention also relates to a hearing aid.

Nowadays, hearing aids are available in different constructions. A hearing aid, such as a hearing device, can be worn behind the ear, completely or partly in the acoustic meatus, or even as a separate device, by the user of the hearing aid. So-called behind the ear (BTE) hearing devices, which are worn behind the ear, are common. In that case, a supporting hook which is affixed to the hearing aid or the hearing device itself, leads from the back side of the ear over the ear into the auditory canal. That supporting hook thus on one hand holds the hearing aid or the hearing device against the ear of the user of the hearing aid and on the other hand supplies the user with output sound of the hearing aid.

In that case, it is usual for the supporting hook to have a passive sound guiding canal, for example in the form of a tube or bore, through which the sound is fed into the auditory canal from the hearing aid. Moreover, so-called receiver-in-canal (RIC) devices are known, in which provision is made for a loudspeaker, that emits sound to the user of the hearing aid, to be located in the supporting hook. In the latter case, it is possible for electrical supply lines from the hearing aid for the loudspeaker to be disposed in the supporting hook.

Furthermore, the supporting hook is usually constructed in such a way that it can be detached from the hearing aid. As a result thereof, it is possible to change the supporting hook, for example for reasons of hygiene. Alternatively, a supporting hook which is adapted specifically to the anatomy of the user can be attached to a standardized, mass-produced hearing device. The mechanical connection of the supporting hook to the hearing aid is subject to specific limitations since, for example, available space, a reasonable overall weight of the hearing aid, mechanical limitations, electrical connections and/or other conditions have to be taken into account.

German Patent DE 43 43 702 C1, corresponding to U.S. Pat. No. 5,708,720, describes a hearing device which can be worn on the head and the housing of which is protected from penetration by high-frequency electromagnetic waves. A supporting hook can be attached through the use of a thread to an earpiece output connection of a lower housing shell of a hearing device housing.

### SUMMARY OF THE INVENTION

It is accordingly an object of the invention to provide an improved hearing aid and an improved supporting hook to be attached to a hearing aid, which overcome the hereinafore-mentioned disadvantages of the heretofore-known devices of this general type.

With the foregoing and other objects in view there is provided, in accordance with the invention, a supporting hook to be attached to a hearing aid. The supporting hook comprises an output end for outputting sound to a user of the hearing aid,

a connection end having a guide, and an attachment ring rotatably mounted about the guide. The attachment ring has a protrusion engaging part of the hearing aid for attaching the connection end to the hearing aid.

With the objects of the invention in view, there is also provided a hearing aid, comprising a supporting hook. The supporting hook includes an output end for outputting sound to a user of the hearing aid, a connection end having a guide, and an attachment ring rotatably mounted about the guide. The attachment ring has a protrusion engaging part of the hearing aid for attaching the connection end to the hearing aid. In this case, the corresponding part of the hearing aid, which engages with the protrusion of the attachment ring can, for example, be part of a thread, a groove or even a bayonet connection or cap.

The provision of an attachment ring on a connection end of the supporting hook permits, on one hand, a detachable connection of the supporting hook to the hearing aid and, on the other hand, a mechanically stable attachment. The attachment ring, which is rotatably mounted in the guide, can therefore fixedly attach the supporting hook onto the hearing aid by fixing the guide relative to the hearing aid and the protrusion of the attachment ring engaging into part of the hearing aid.

In accordance with another feature of the invention, the guide has an annular flange. An axial symmetry of such an annular flange allows the supporting hook to be attached to the hearing aid with an arbitrary orientation and can furthermore make it possible to distribute the attachment force over the entire annular flange. This can be advantageous, particularly when taking into account the limited spatial conditions in hearing aids. Forces, due to normal use or faulty operation, can act on the supporting hook/hearing aid connection and can lead to damage of the supporting hook or part of the hearing aid in the case of insufficient distribution.

In accordance with a further feature of the invention, the guide has a groove around the connection end of the supporting hook. The provision of a groove can afford the possibility of the attachment ring, on one hand, stably attaching the supporting hook to the hearing aid and, on the other hand, being undetachably affixed to the supporting hook, with a rotatable mount still being ensured. In this case, the attachment force is imparted through a first side face of the groove and the attachment ring is undetachably held on the supporting hook through a second side face of the groove.

In accordance with an added feature of the invention, the protrusion has a hook, which engages with a thread of the hearing aid. The provision on the hearing aid of a simple thread into which the hook of the attachment ring can engage is thus made possible. Furthermore, a hook does not require a complete thread, but also affords the possibility of engaging into a groove or part of a bayonet connection or cap. Hence, the attachment ring can advantageously be affixed to a number of hearing aids, with this being independent of the hearing aid having a thread, a groove or part of a bayonet connection or cap.

In accordance with an additional feature of the invention, the protrusion of the attachment ring is part of a bayonet connection or cap. Hence, the supporting hook can advantageously be affixed through the use of a bayonet connection or cap which is easy to operate. The latter is also able to advantageously prevent undesired detachment of the supporting hook through the use of its locking device.

In accordance with yet another feature of the invention, the protrusion is part of a thread of the attachment ring. Hence, the attachment ring can fixedly engage into a corresponding mating thread of the hearing aid. Therefore, the supporting hook can be affixed to the hearing aid in a particularly stable manner. In this case, the thread of the attachment ring can be a female thread, so that the attachment ring can be constructed as a sleeve nut. Hence, all connection elements can advantageously be sealed in the affixed state, so that contamination and/or humidity can advantageously be kept away from the mechanical connection, an electrical connection or the interior of the hearing aid.

In accordance with yet a further feature of the invention, the attachment ring is made of metal. Examples for this are stainless special steel, steel, aluminum, titanium, magnesium, other light metals and/or alloys thereof. Furthermore, the attachment ring can also be produced from a stable plastic. It may become necessary to transfer the occurring attachment forces onto small elements due to the limited space available to the supporting hook and the attachment ring for it in a region of the ear of the user of the hearing aid. The provision of the attachment ring made of metal or a stable plastic can advantageously ensure a stable and robust connection of the supporting hook. Hence, the supporting hook and/or the hearing aid can have increased stability, and breakage or damage of the supporting hook and/or parts of the hearing aid due to normal use by the user or even due to faulty operation can be avoided.

In accordance with yet an added feature of the invention, a longitudinal axis is defined along the connection end, and the supporting hook is intended to be rotatably attached to the hearing aid with an arbitrary orientation about the longitudinal axis. Hence the supporting hook can advantageously be rotated in a state where it is attached to the hearing aid in order to, for example, be adapted to the anatomy of the user of the hearing aid.

In accordance with yet an additional feature of the invention, an electrical contact is disposed on the connection end in order to provide an electrical connection to the hearing aid. Hence electronic and/or electrical elements can be disposed in the supporting hook. This is particularly advantageous in so-called receiver-in-canal (RIC) embodiments, in which a loudspeaker is disposed in the supporting hook for outputting sound to the user of the hearing aid. Hence, it is possible for signals from the hearing aid to be transferred to corresponding electrical and/or electronic units in the supporting hook through the electrical contact.

In accordance with a concomitant feature of the invention, the supporting hook is formed of a flexible material, or is produced from a flexible material, so that it can be adapted to the anatomy of the user of the hearing aid. Hence it is advantageously possible to improve the adaptation of the supporting hook to the anatomy of the user of the hearing aid in a state in which it is already attached to the hearing aid.

Other features which are considered as characteristic for the invention are set forth in the appended claims.

Although the invention is illustrated and described herein as embodied in a hearing aid and a supporting hook to be attached to a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, side-elevational view of a supporting hook and part of a hearing aid according to a first embodiment of the present invention, in a separated state;

FIG. 2 is a fragmentary, side-elevational view of a supporting hook and part of a hearing aid according to the first embodiment of the present invention, in an attached state;

FIG. 3 is a fragmentary, side-elevational view of a supporting hook and part of a hearing aid according to a second embodiment of the present invention and FIG. 3A is an enlarged view of a portion thereof;

FIG. 4 is a fragmentary, side-elevational view of a supporting hook and part of a hearing aid according to a third embodiment of the present invention and FIG. 4A is an enlarged view of a portion thereof;

FIG. 5 is a fragmentary, side-elevational view of a supporting hook and part of a hearing aid according to a fourth embodiment of the present invention;

FIG. 6 is a fragmentary, side-elevational view of a supporting hook and part of a hearing aid according to a fifth embodiment of the present invention; and

FIG. 7 is a fragmentary, side-elevational view of a supporting hook and part of a hearing aid according to a sixth embodiment of the present invention.

### DETAILED DESCRIPTION OF THE INVENTION

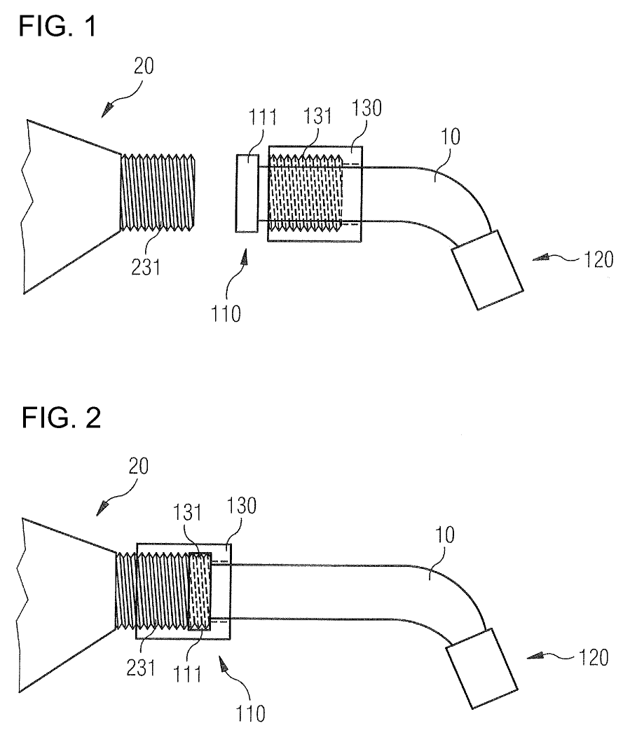

Referring now to the figures of the drawings in detail and first, particularly, to FIG. 1 thereof, there is seen a diagrammatic illustration of a supporting hook and part of a hearing aid according to a first embodiment of the present invention, in a separated state. In this case, a supporting hook 10 has a connection end 110 and an output end 120. The connection end 110 of the supporting hook 10 is affixed to a hearing aid 20. Furthermore, sound for the user of the hearing aid 20 is output at the output end 120 of the supporting hook 10. For this purpose, the supporting hook 10 can have a channel or a bore through which the sound is fed from the hearing aid 20 to the output end 120. According to this embodiment of the present invention, the supporting hook 10 has an attachment ring 130, which is rotatably mounted about the connection end 110 of the supporting hook 10. Furthermore, the attachment ring 130 has a protrusion 131, for example in the form of a female thread. According to this embodiment, provision is made on the hearing aid 20 for a corresponding mating thread 231, for example a male thread, in order to affix the supporting hook 10 to the hearing aid 20.

FIG. 2 diagrammatically shows the supporting hook and part of the hearing aid according to the first embodiment of the present invention in an attached state. For this purpose, the attachment ring 130 was rotated over the corresponding connection part of the hearing aid 20 in such a manner that the protrusion 131 engaged with the thread 231. The attachment ring 130 thus pushes the connection end 110 against the hearing aid 20 through the use of a guide 111. Hence, the supporting hook 10 is advantageously affixed to the hearing aid 20 in a detachable, but simultaneously stable and robust manner.

In this case, the attachment ring 130 and/or parts of the hearing aid 20 can be made from metal or plastic. Metals or corresponding plastics which have increased bending stiffness thus ensure a stable and robust attachment while requiring little space. Advantageously, it is possible, for example, to use stainless special steel, steel, aluminum, titanium, magnesium, other light metals and/or alloys thereof to make or produce the attachment ring 130 and/or parts of the hearing aid 20.

However, the provision of an attachment ring 130 also advantageously permits a construction using heavier materials, such as special steel, since only the ring 130 has to be made from this material. The supporting hook 10 and the hearing aid 20 can still be made from light and/or ergonomic materials, with stable attachment of the supporting hook 10 to the hearing aid 20 being able to be ensured at the same time by a stably constructed attachment ring 130. In addition to the advantages of an increased selection of available materials, a corresponding two-part construction can afford the possibility of using standardized parts together with parts made specifically for the user, or even of a partial interchange.

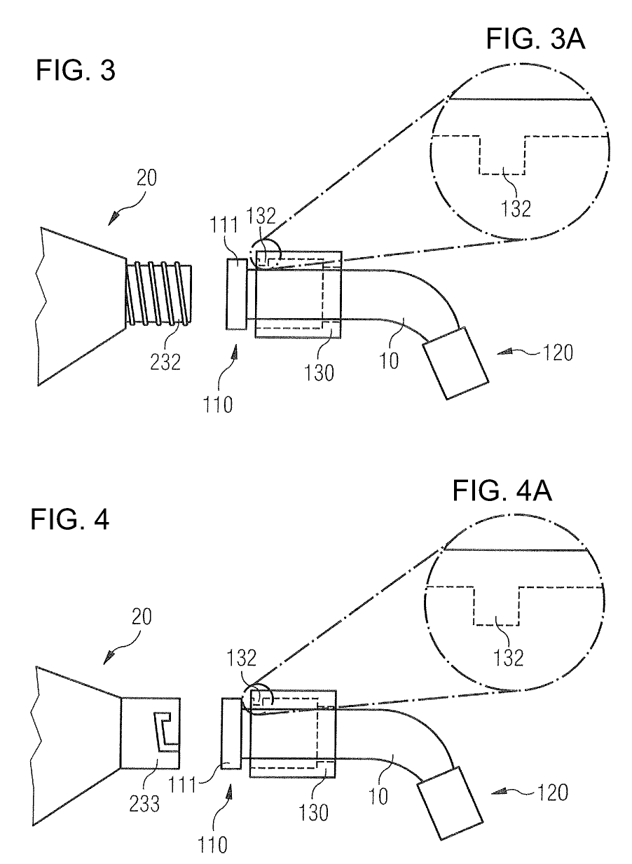

FIG. 3 shows a supporting hook and part of a hearing aid according to a second embodiment of the present invention. According to this embodiment, the attachment ring 130 has a protrusion in the form of a hook 132, which is best seen in FIG. 3A. The hook 132 can engage into a groove 232 of a corresponding connection part of the hearing aid 20. The hook 132 affords the possibility, on one hand, of stably attaching the supporting hook 10 to the hearing aid 20 and, on the other hand, a simple construction of the attachment ring 130. Hence, the attachment ring 130 can advantageously be produced particularly easily, since complex molding and/or processing steps, such as for example shaping or cutting a thread, can be dispensed with.

FIG. 4 diagrammatically shows a supporting hook and part of a hearing aid according to a third embodiment of the present invention. Accordingly, a corresponding connection end of the hearing aid 20 has a bayonet groove 233. The hook 132 of the attachment ring 130, which is best seen in FIG. 4A, can thus engage into the groove 233. In this way, the supporting hook 10 is stably attached to the hearing aid 20. However, the bayonet connection or cap according to this embodiment at the same time affords the possibility, on one hand, of stably and simply attaching the supporting hook 10 to the hearing aid 20 and, on the other hand, an appropriate attachment which effectively prevents undesired detachment.

In the case of a threaded construction, undesired detachment of the attachment ring 130 from the connection part of the hearing aid 20 can, for example, be the result of movement of the user of the hearing aid. In this case, the hold of a bayonet connection or cap can be substantially less sensitive to detachment due to vibrations and/or movements. Furthermore, simple and quick attachment of the supporting hook to the hearing aid 20 is possible due to the reduced required rotational path of the attachment ring 130.

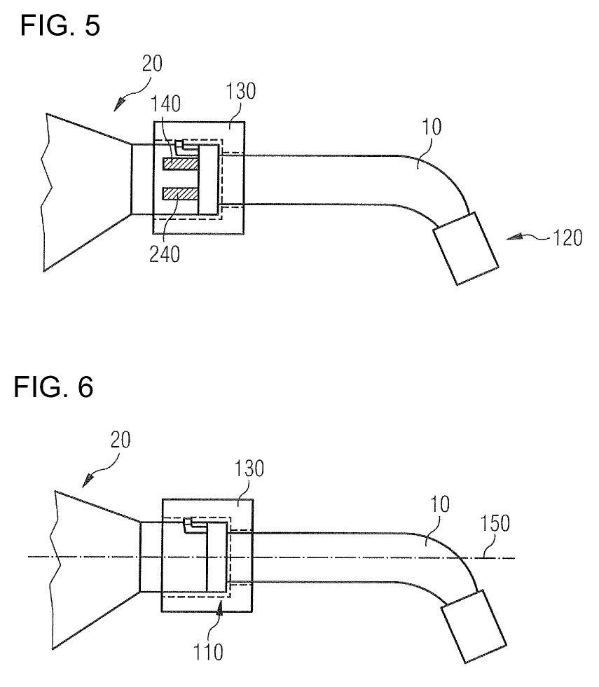

FIG. 5 diagrammatically shows a supporting hook and part of a hearing aid according to a fourth embodiment of the present invention. Accordingly, the supporting hook 10 is affixed by the attachment ring 130 to the corresponding part or attachment end of the hearing aid 20. The supporting hook 10 can be attached according to one of the previously described embodiments of the present invention. The illustrated bayonet connection can therefore be replaced by a thread and/or hook/groove connection.

According to this embodiment of the present invention, an electrical contact, such as a plug 140, is situated on the connection end 111 of the supporting hook 10 and engages with corresponding sockets 240 of the hearing aid 20. The plugs 140 can provide an electrical connection from the supporting hook 10 to the hearing aid 20. Thus, provision can advantageously be made for electrical and/or electronic units in the supporting hook 10. The units can be connected to further electrical and/or electronic units of the hearing aid 20 through the plug 140/socket 240 connection. This can be advantageous particularly in the case of so-called receiver-in-canal (RIC) embodiments because, on one hand, the supporting hook 10 can be attached to the hearing aid 20 in a detachable and stable manner by the attachment ring 130 and, on the other hand, this affords the possibility of an electrical connection to a loudspeaker provided in the supporting hook 10. In addition to a loudspeaker, provision can be made for additional electronic units in the supporting hook 10, such as amplifiers, microphones, operating elements and/or other sensors.

FIG. 6 shows a supporting hook and part of a hearing aid according to a fifth embodiment of the present invention. In this case, the supporting hook 10 is affixed with the attachment ring 130 to a corresponding connection end of the hearing aid 20. The attachment can be effected in accordance with one of the previously described embodiments of the present invention. According to this embodiment, the supporting hook 10 is rotatably disposed about a longitudinal axis 150, even in a state where it is attached to the hearing aid 20. In this case, the longitudinal axis 150 is aligned along a longitudinal axis of the connection end 110 of the supporting hook 10. Accordingly, the position of the supporting hook 10 along the longitudinal axis 150 can advantageously be adapted even in an attached state. This can substantially simplify the application and operation of the hearing aid.

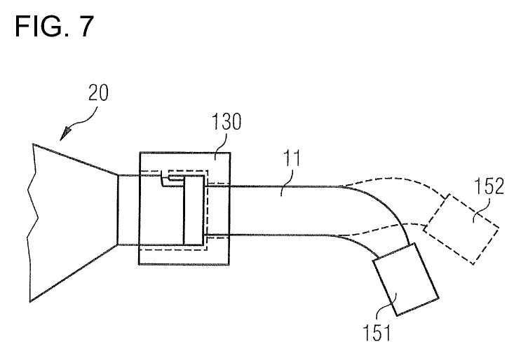

FIG. 7 diagrammatically shows a supporting hook and part of a hearing aid according to a sixth embodiment of the present invention. Accordingly, a supporting hook 11 is attached with the attachment ring 130 to the hearing aid 20. The supporting hook 11 can be attached to the hearing aid 20 in accordance with one of the previously described embodiments of the present invention. According to this embodiment, the supporting hook 11 has an elastic material or is made from an elastic material. Hence, the supporting hook 11 can also be changed in a state where it has already been attached to the hearing aid 20 and/or it can be adapted to the anatomy of a user of the hearing aid. For example, the supporting hook 11 can be shaped into a first shape 151 and a second shape 152. The flexible material can have temperature dependent flexibility and/or elastic properties. Hence, the supporting hook 11 can advantageously also be adapted to the anatomy of the user of the hearing aid when it is in an attached state and being worn.

1. A supporting hook to be attached to a hearing aid, the supporting hook comprising:
an output end for outputting sound to a user of the hearing aid;
a connection end having a guide; and
an attachment ring rotatably mounted about said guide, said attachment ring having a protrusion engaging part of the hearing aid for attaching said connection end to the hearing aid.

2. The supporting hook according to claim 1, wherein said guide has an annular flange.

3. The supporting hook according to claim 1, wherein said guide has a groove around said connection end.

4. The supporting hook according to claim 1, wherein said protrusion has a hook engaging a thread of the hearing aid.

5. The supporting hook according to claim 1, wherein said protrusion is part of a bayonet connection.

6. The supporting hook according to claim 1, wherein said protrusion is part of a thread of said attachment ring, and said thread of said attachment ring engages a thread of the hearing aid.

7. The supporting hook according to claim 6, wherein said thread of said attachment ring is a female thread.

8. The supporting hook according to claim 1, wherein said attachment ring is made of metal.

9. The supporting hook according to claim 1, wherein said connection end defines a longitudinal axis along said connection end, and said supporting hook is configured to be rotatably attached to the hearing aid with an arbitrary orientation about said longitudinal axis.

10. The supporting hook according to claim 1, which further comprises an electrical contact disposed on said connection end for providing an electrical connection to the hearing aid.

11. The supporting hook according to claim 1, which further comprises a loudspeaker outputting sound to the user of the hearing aid.

12. The supporting hook according to claim 1, wherein the supporting hook is formed of a flexible material permitting the supporting hook to be adapted to the anatomy of the user of the hearing aid.

13. The supporting hook according to claim 1, wherein the supporting hook is configured for attachment to a behind the ear hearing device.

14. A hearing aid, comprising a supporting hook according to claim 1.

15. The hearing aid according to claim 15, wherein the hearing aid is a behind the ear hearing device.

16. The hearing aid according to claim 15, wherein said supporting hook has a receiver-in-canal.
